(19) United States
(12) Patent Application Publication
(10) Pub. No.: US 2024/0377705 A1
(43) Pub. Date: Nov. 14, 2024

(54) CAMERA MODULE

(71) Applicant: Samsung Electro-Mechanics Co., Ltd., Suwon-si (KR)

(72) Inventors: Su Kyeong KIM, Suwon-si (KR); Oh Byoung KWON, Suwon-si (KR); Do Seop HWANG, Suwon-si (KR); Chuel Jin PARK, Suwon-si (KR)

(73) Assignee: Samsung Electro-Mechanics Co., Ltd., Suwon-si (KR)

(21) Appl. No.: 18/465,241

(22) Filed: Sep. 12, 2023

(30) Foreign Application Priority Data
May 9, 2023 (KR) 10-2023-0060091

(51) Int. Cl. G03B 5/02; G03B 13/36

(52) U.S. Cl. CPC G03B 5/02; G03B 13/36; G03B 2205/0069

(57) ABSTRACT

A camera module is provided. The camera module includes a lens unit including at least one lens; a first carrier which accommodates the lens unit and is configured to move in an optical axis direction; a second carrier which accommodates the first carrier and is configured to move on a plane, perpendicular to an optical axis; and a base on which the second carrier is disposed, wherein a plurality of balls that guide a movement of the second carrier on the plane, perpendicular to the optical axis, are disposed between the second carrier and the base.

### CROSS-REFERENCE TO RELATED APPLICATIONS

This application claims the benefit under 35 USC § 119(a) of Korean Patent Application No. 10-2023-0060091 filed on May 9, 2023, in the Korean Intellectual Property Office, the entire disclosure of which is incorporated herein by reference for all purposes.

### BACKGROUND

### 1. Field

The following description relates to a camera module.

### 2. Description of Related Art

Camera modules are implemented in portable electronic devices such as, but not limited to, smartphones, tablet personal computers (PCs), laptop computers, or the like. Additionally, the camera module may be provided with various operations such as an autofocus adjusting operation (autofocusing (AF)), an image stabilization operation (optical image stabilization (OIS)), a zoom operation (Zoom), or the like.

In an example, since the camera module may perform various operations, performance of the camera module may increase. However, since a size and a weight of the camera module may inevitably increase in view of the additional operations, the performance of the camera module may deteriorate. Specifically, an increase in weight of the camera module may be disadvantageous in securing driving stability during focus adjustment.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a lens unit comprising at least one lens; a first carrier, which accommodates the lens unit, and is configured to move in an optical axis direction; a second carrier, which accommodates the first carrier, and is configured to move on a plane, perpendicular to the optical axis direction; and a base on which the second carrier is disposed, wherein a plurality of balls that guide a movement of the second carrier on the plane, perpendicular to the optical axis, are disposed between the second carrier and the base.

The second carrier and the base may include guide grooves that respectively accommodate the plurality of balls on surfaces that face each other in the optical axis direction, and wherein the plurality of balls may be in contact with the guide grooves at one point, respectively.

The camera module may further include a connection substrate disposed in an external space of the second carrier and formed of a flexible material to support a rotation of the second carrier.

The connection substrate may include a first portion disposed on the second carrier; a second portion spaced apart from a side surface of the second carrier; and a third portion disposed on the base, wherein a portion of the second portion has a curved shape.

The camera module may further include a clip portion to which the second portion is fixed; and a support portion on which the third portion is disposed, and attached to the base.

The camera module may further include a first substrate disposed on the second carrier to face the first carrier in a direction, perpendicular to the optical axis direction; and a second substrate disposed on the base to face the second carrier in the optical axis direction, wherein the first substrate is connected to the connection substrate.

The camera module may further include a first magnet disposed on a first surface of the first carrier; and a first coil disposed on the second carrier to face the first magnet in a direction, perpendicular to the optical axis direction, wherein the first carrier is moved in the optical axis direction by an electromagnetic force generated by the first magnet and the first coil.

The camera module may further include a second magnet and a third magnet, disposed on a first surface of the second carrier; and a second coil and a third coil, disposed on the base to respectively face the second magnet and the third magnet in the optical axis direction, wherein the second carrier is configured to move in a first direction and a second direction, perpendicular to the optical axis direction, based on an electromagnetic force generated by the second magnet and the third magnet and the second coil and the third coil.

The camera module may further include a first sensing magnet and a second sensing magnet, disposed on a first surface of the second carrier, wherein the first sensing magnet may have a shape in which one surface of the first sensing magnet facing the base in the optical axis direction is magnetized in the first axis direction, and the second sensing magnet may have a shape in which one surface of the second sensing magnet facing the base in the optical axis direction is magnetized in the second axis direction.

The camera module may further include a position sensor disposed on the base to respectively face the first sensing magnet and the second sensing magnet in the optical axis direction.

The camera module may further include a pulling yoke disposed on the base to respectively face the first sensing magnet and the second sensing magnet in the optical axis direction, wherein an attractive force may act between the first sensing magnet and the second sensing magnet and the pulling yoke in opposite directions.

An electronic may include the camera module.

In a general aspect, a camera module includes a base; a second carrier configured to move relative to the base on a plane, perpendicular to an optical axis direction, and including a rounded portion; a first carrier configured to move relatively with respect to the second carrier in the optical axis direction; and a connection substrate configured to support a movement of the second carrier in a state in which a first side of the connection substrate is disposed on the second carrier and a second side of the connection substrate is disposed on the base, wherein the connection substrate includes a curved region along the rounded portion of the second carrier.

The curved region of the connection substrate may be spaced apart from the second carrier in a direction, perpendicular to the optical axis direction.

The camera module may include a second magnet and a third magnet, disposed on the second carrier; and a second coil and a third coil, disposed on the base to respectively face the second magnet and the third magnet in the optical axis direction, wherein the second magnet and the third magnet are disposed at positions spaced apart from the rounded portion of the second carrier in the optical axis direction.

The second carrier may be configured to move relatively with respect to the base in a first direction and a second direction, perpendicular to the optical axis, by an electromagnetic force generated by the second magnet and the third magnet and the second coil and the third coil, and wherein the second magnet and the third magnet are disposed on the second carrier such that a longitudinal direction intersects a first axis and a second axis, perpendicular to the optical axis.

The second coil and the third coil may be disposed on the base in a state of being mounted on a substrate, and wherein the substrate may include a portion on which the second coil is mounted and a portion on which the third coil is mounted, and the second coil and the third coil are structurally separated to be spaced apart from each other on the base.

In a general aspect, a camera module includes a base; a first carrier configured to move in an optical axis direction; a second carrier configured to accommodate the first carrier, and configured to move in a direction perpendicular to the optical axis direction; and a connection board, connected to the base and the second carrier, and configured to support the second carrier, and move together with the second carrier when the second carrier moves in the direction perpendicular to the optical axis direction.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a schematic exploded perspective view of an example camera module, in accordance with one or more embodiments.

FIG. 3 illustrates an exploded perspective view of an example camera module, in accordance with one or more embodiments.

FIG. 4 illustrates a perspective view illustrating an example in which a first carrier is accommodated in a second carrier, in accordance with one or more embodiments.

FIG. 5 illustrates a plan view of FIG. 4.

FIG. 6 illustrates a perspective view of an example in which a first substrate is separated from FIG. 4.

FIG. 7 illustrates a perspective view illustrating an example in which a first carrier and a second carrier are accommodated in a base, in accordance with one or more embodiments.

FIG. 8 illustrates a perspective view illustrating a second driver, in accordance with one or more embodiments.

FIG. 9 illustrates a bottom view of a second carrier, in accordance with one or more embodiments.

FIG. 10 illustrates a perspective view of an example in which a second substrate is coupled to a base, in accordance with one or more embodiments.

FIG. 11 illustrates a perspective view of an example in which a third substrate is separated from FIG. 7.

FIG. 12 illustrates a view of a position to which a first substrate and a third substrate, in accordance with one or more embodiments, are coupled.

FIG. 13 is a side view of FIG. 1.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

In the one or more examples, an optical axis direction may mean a direction, extending vertically along an optical axis of a lens module, or a direction, parallel to the optical axis, a first direction may mean a direction, perpendicular to the optical axis direction, and a second direction may mean a direction, perpendicular to both the optical axis direction and the first direction.

One or more examples may provide a camera module having improved driving stability during focus adjustment.

The one or more examples relate to a camera module 1 mounted on an example portable electronic device. As only examples, the portable electronic device may be a smartphone, and may also be a mobile communication terminal, a tablet PC, a laptop computer, or the like.

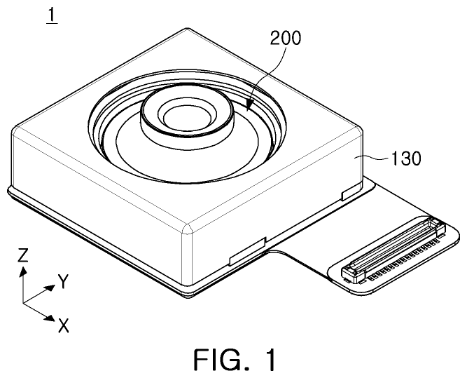

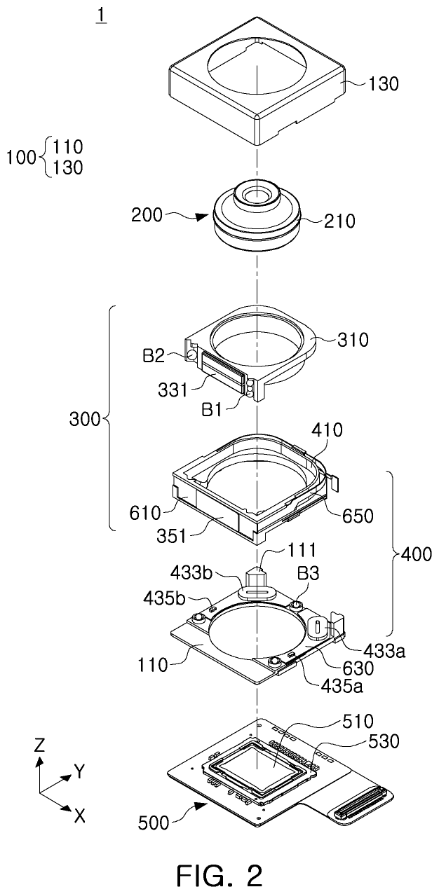

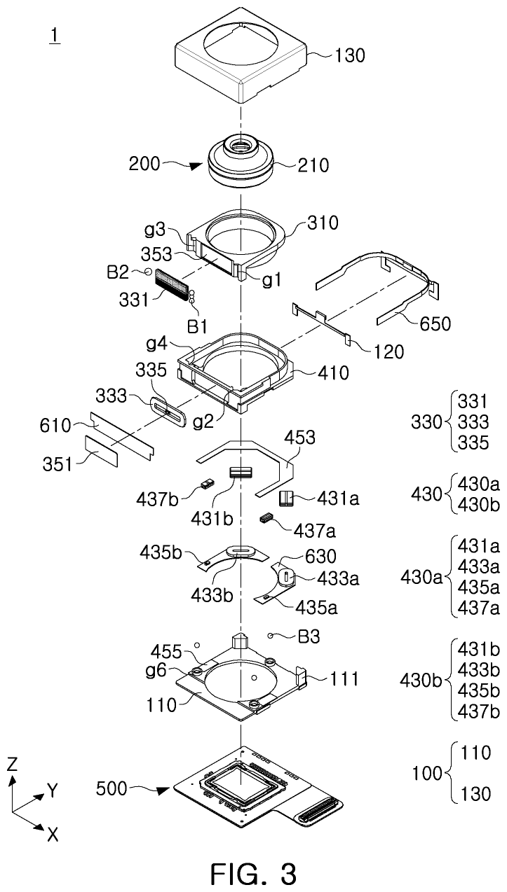

FIG. 1 illustrates a perspective view of an example camera module, in accordance with one or more embodiments, FIG. 2 is a schematic exploded perspective view of an example camera module, in accordance with one or more embodiments, and FIG. 3 is an exploded perspective view of an example camera module, in accordance with one or more embodiments.

Referring to FIG. 2, an example camera module 1, in accordance with one or more embodiments may include a housing unit 100 (110, 130), a lens unit 200, a focus adjustment unit 300, a shake correction unit 400, and an image sensor unit 500.

The lens unit 200, the focus adjustment unit 300, and the shake correction unit 400 may be accommodated in the housing unit 100. Additionally, the lens unit 200 may be accommodated in the focus adjustment unit 300, and the focus adjustment unit 300 may be accommodated in the shake correction unit 400. The image sensor unit 500 may be coupled to the housing unit 100.

The housing unit 100 may include a base 110 and a case 130.

The base 110 may have a square plate shape with a central portion perforated in an optical axis (Z-axis) direction. Additionally, the base 110 may include a support wall 111 that extends from two corner portions in the optical axis (Z-axis) direction. A portion of a third substrate 650 to be described later may be mounted on the support wall 111.

The case 130 may be coupled to the base 110 to form a space in which the lens unit 200 or the like is accommodated, and may protect the same. Additionally, the case 130 may be formed of a material including metal (e.g., aluminum), and may thus have an electromagnetic wave shielding operation.

In an example, the housing unit 100, e.g., the base 110 and the case 130 may be a fixed body.

The lens unit 200 may include at least one lens and a lens barrel 210 in which the at least one lens is mounted. When the lens unit 200 includes a plurality of lenses, the plurality of lenses may be mounted in the lens barrel 210 in the optical axis (Z-axis) direction.

In an example, the lens unit 200 may be a moving member that moves in the optical axis (Z-axis) direction during focus adjustment, and moves on a plane (X-Y plane), perpendicular to an optical axis (Z-axis), during shake correction.

The image sensor unit 500 may be fixedly coupled to the base 110.

The image sensor unit 500 may include an image sensor 510 that has an imaging surface, and a sensor substrate 530 on which the image sensor 510 is disposed. The sensor substrate 530 may be a printed circuit board (PCB), and the image sensor 510 and the sensor substrate 530 may be electrically connected through wire bonding.

Additionally, the image sensor unit 500 may further include an infrared cut filter (not illustrated) disposed between the lens unit 200 and the image sensor 510 to block light in an infrared region among light incident through the lens unit 200.

The imaging surface of the image sensor 510 may be disposed to face in the optical axis (Z-axis) direction, and a center of the imaging surface may (approximately) coincide with the optical axis (Z-axis) of the plurality of lenses. The image sensor 510 may convert light passing through a plurality of lenses into an electrical signal, and the converted electrical signal may be output as an image through a display unit of a portable electronic device. For example, the image sensor 510 may be a charge coupled device (CCD) or a complementary metal-oxide semiconductor (CMOS).

The focus adjustment unit 300 may include a first carrier 310 and a first driver 330.

The first carrier 310 may be a moving member that moves in the optical axis (Z-axis) direction during focus adjustment. The lens unit 200 may be accommodated in the first carrier 310, and thus the lens unit 200 may move along with the first carrier 310 in the optical axis (Z-axis) direction during focus adjustment.

The first driver 330 may be an actuator that includes a magnet and a coil. The first driver 330 may generate a driving force to move the first carrier 310 in the optical axis (Z-axis) direction.

The first driver 330 may be separately disposed in the first carrier 310 and a second carrier 410 of the shake correction unit 400 to be described later.

The shake correction unit 400 may include a second carrier 410 and a second driver 430.

The second carrier 410 may be a moving member that moves on a plane (X-Y plane), perpendicular to the optical axis (Z-axis), during shake correction. The first carrier 310 and the lens unit 200 may be accommodated in the second carrier 410, and accordingly, the first carrier 310 and the lens unit 200 may move on a plane (X-Y plane), perpendicular to the optical axis (Z-axis), along with the second carrier 410 during shake correction. The second carrier 410 may be a fixed member that does not move in the optical axis (Z-axis) direction during focus adjustment.

The second driver 430 may be an actuator that includes a magnet and a coil. The second driver 430 may generate a driving force to move the second carrier 410 in a direction, perpendicular to the optical axis (Z-axis). The second driver 430 may be separately disposed on the second carrier 410 and the base 110 of the housing unit 100.

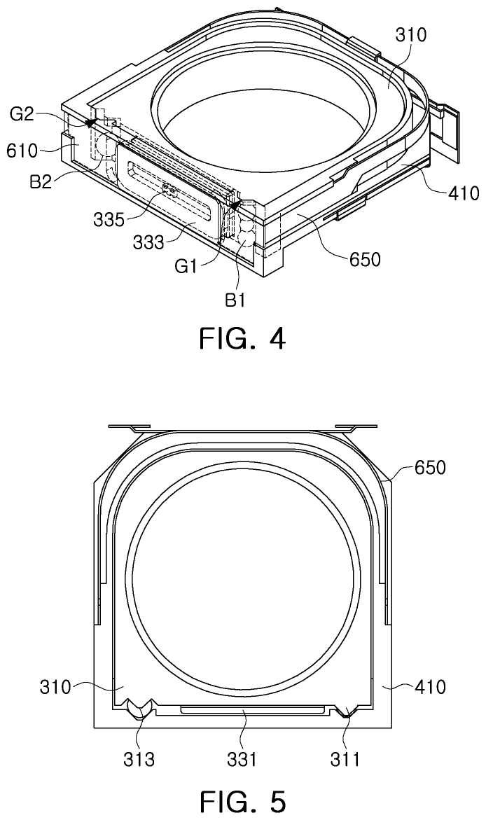

Hereinafter, a focus adjustment unit 300 and a shake correction unit 400, in accordance with one or more embodiments, will be described in detail with reference to FIGS. 4 to 13.

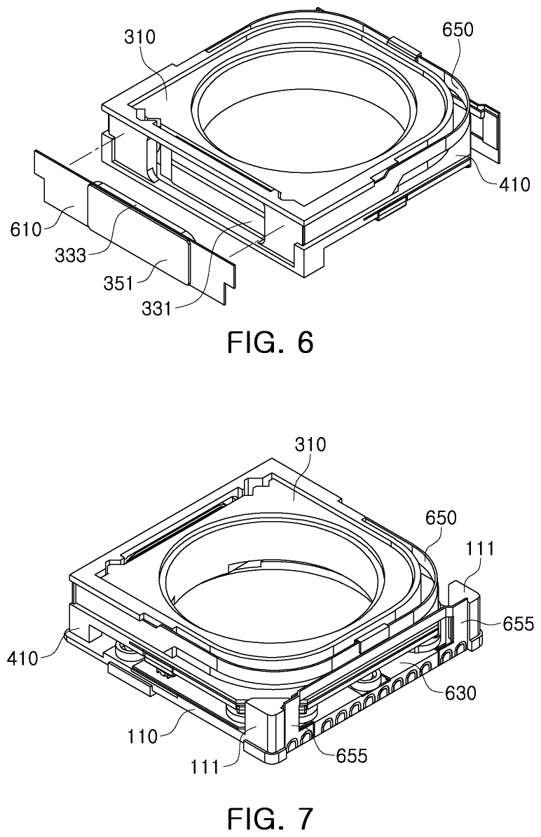

FIG. 4 illustrates a perspective view of an example in which a first carrier is accommodated in a second carrier, in accordance with one or more embodiments, FIG. 5 illustrates a plan view of FIG. 4, and FIG. 6 illustrates a perspective view of an example in which a first substrate is separated from FIG. 4.

In an example, a focus adjustment unit 300 may be accommodated in a shake correction unit 400.

Specifically, a first carrier 310 of the focus adjustment unit 300 may be accommodated in a second carrier 410 of the shake correction unit 400, and the first carrier 310 may be accommodated in the second carrier 410, and, in this example, may move relatively in the optical axis (Z-axis) direction with respect to the second carrier 410. Since a lens unit 200 may be accommodated in the first carrier 310, the lens unit 200 may move in the optical axis (Z-axis) direction, together with the first carrier 310. In this process, as a distance between the lens unit 200 and an image sensor 510 fixedly coupled to a base 110 in the optical axis (Z-axis) direction is changed, focus may be adjusted.

In an example, a structure in which the focus adjustment unit 300 is accommodated in the shake correction unit 400 may be advantageous to secure a difference in posture, due to a relatively low weight of a portion moved in the optical axis (Z-axis) direction during focus adjustment.

A first driver 330 may be a portion that provides a driving force to move the first carrier 310 in the optical axis (Z-axis) direction, and may include a first magnet 331 and a first coil 333.

The first driver 330 may be disposed separately between the first carrier 310 and the second carrier 410. For example, the first magnet 331 may be disposed on the first carrier 310, and the first coil 333 may be disposed on the second carrier 410. The first magnet 331 and the first coil 333 may face each other in a direction, perpendicular to an optical axis (Z-axis), while being disposed on the first carrier 310 and the second carrier 410, respectively.

The first magnet 331 may be disposed on one side surface of the first carrier 310, and a back yoke 353 may be disposed between the first magnet 331 and the first carrier 310. In an example, the back yoke 353 may be integrally formed with the first carrier 310 by insert injection molding. A portion of the back yoke 353 may be disposed in the first carrier 310, and a remaining portion thereof may be disposed to be exposed to an outside of the first carrier 310. The first magnet 331 may be disposed on the portion of the back yoke 353 exposed to the outside of the first carrier 310. The back yoke 353 may focus a magnetic force of the first magnet 331, and may prevent the occurrence of leakage magnetic flux.

In an example, the first coil 333 may be disposed on one side surface of the second carrier 410 to face the first magnet 331 while being mounted on one surface of a substrate (hereinafter, a first substrate) 610. In an example, the first substrate 610 on which the first coil 333 or the like is mounted may be disposed on the second carrier 410.

The first magnet 331 may be magnetized such that one surface facing the first coil 333 has an N pole (or an S pole), a neutral region, and an S pole (or an N pole) in the optical axis (Z-axis) direction. Additionally, as power is applied to the first coil 333, a driving force to move the first carrier 310 in the optical axis (Z-axis) direction may be formed.

In an example, the first magnet 331 may be a moving member that moves in the optical axis (Z-axis) direction, together with the first carrier 310, and the first coil 333 may be a fixed member with respect to the optical axis (Z-axis) direction.

The first driver 330 may include a first position sensor 335 that senses a position of the first carrier 310 in the optical axis (Z-axis) direction. The first position sensor 335 may be mounted on one surface of the first substrate 610, together with the first coil 333, and may face the first magnet 331 in a direction, perpendicular to the optical axis (Z-axis). In an example, the first position sensor 335 may be a hall sensor.

One or more ball members may be disposed between the first carrier 310 and the second carrier 410, and the one or more ball members may guide a movement of the first carrier 310 in the optical axis (Z-axis) direction. In an example, a first ball member B1 and a second ball member B2, respectively including at least one ball (sphere), may be disposed between the first carrier 310 and the second carrier 410. In an example, the first ball member B1 and the second ball member B2 may be respectively disposed on both sides of the first magnet 331 in a longitudinal direction thereof.

The first carrier 310 and the second carrier 410 may respectively include a first guide groove portions G1 and a second guide groove portion G2, which extend in a direction parallel to the optical axis (Z-axis) direction on both sides of the first magnet 331 in the longitudinal direction, respectively.

The first guide groove portion G1 may include a first guide groove g1 formed in the first carrier 310, and a second guide groove g2 formed in the second carrier 410 to face the first guide groove g1. The first ball member B1 may be disposed in the first guide groove portion G1.

Additionally, the second guide groove portion G2 may include a third guide groove g3 formed in the first carrier 310, and a fourth guide groove g4 formed in the second carrier 410 to face the third guide groove g3. The second ball member B2 may be disposed in the second guide groove portion G2.

Any one of the first ball member B1 or the second ball member B2 may be a main guide that guides a movement of the first carrier 310 in the optical axis (Z-axis) direction, and the other thereof may be an auxiliary guide that supports the movement of the first carrier 310 in the optical axis (Z-axis) direction. In an example, referring to FIG. 4, the first ball member B1 may be a main guide, and the second ball member B2 may be an auxiliary guide.

The first guide groove portion G1 and the second guide groove portion G2 may regulate movement ranges of the first ball member B1 and the second ball member B2, and may include a first protrusion 311 and a second protrusion 313.

Referring to FIG. 5, on upper ends of the first guide groove g1 and the third guide groove g3 formed in the first carrier 310, the first protrusion 311 and the second protrusion 313 may protrude toward the second guide groove g2 and the fourth guide groove g4. The first protrusion 311 and the second protrusion 313 may be accommodated in the second guide groove g2 and the fourth guide groove g4, respectively, while the first carrier 310 is accommodated in the second carrier 410. Therefore, separation of the first ball member B1 and the second ball member B2, or the like may be prevented.

Referring to FIG. 3, a first yoke 351 may be mounted on the other surface of the first substrate 610. The first yoke 351 may face the first magnet 331 in a direction, perpendicular to the optical axis (Z-axis), and an attractive force may act between the first magnet 331 and the first yoke 351 in opposite directions. The first ball member B1 and the second ball member B2 may maintain contact with the first carrier 310 and the second carrier 410 based on the attractive force generated in this manner.

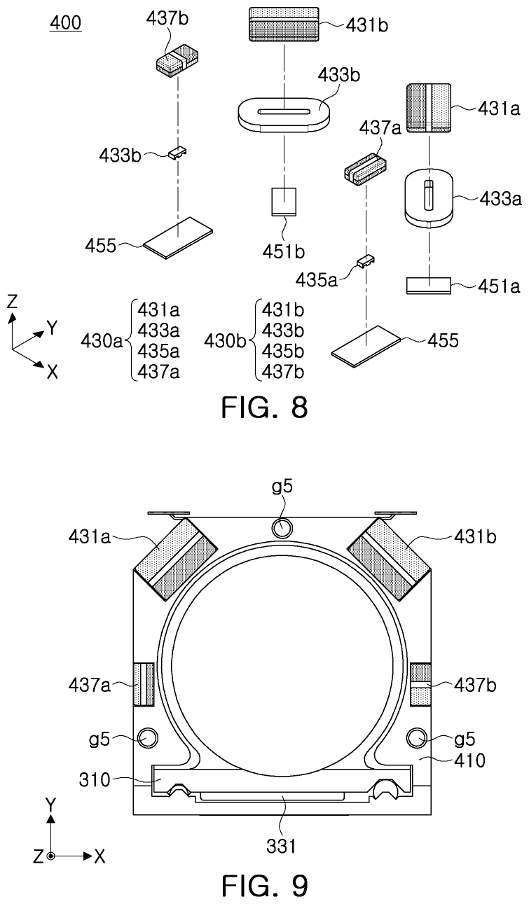

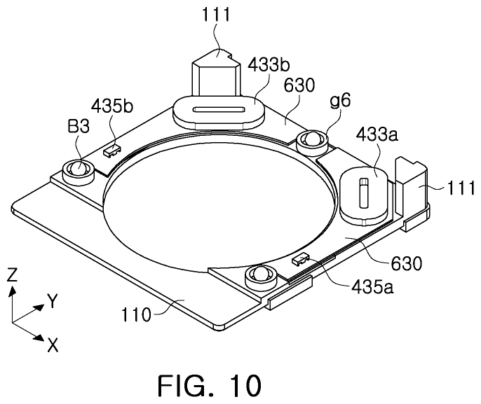

FIG. 7 illustrates a perspective view of an example in which a first carrier and a second carrier are accommodated in a base, in accordance with one or more embodiments. FIG. 8 illustrates a perspective view of an example second driver, in accordance with one or more embodiments. FIG. 9 illustrates a bottom view of an example second carrier, in accordance with one or more embodiments. FIG. 10 illustrates a perspective view of an example in which a second substrate is coupled to a base, in accordance with one or more embodiments.

In an example, a shake correction unit 400 may be accommodated in a housing unit 100.

Specifically, a second carrier 410 of the shake correction unit 400 may be accommodated in (or disposed on) a base 110 of the housing unit 100, and the second carrier 410 may be attached to the base 110. In the accommodated state, the second carrier 410 may relatively move on a plane (X-Y plane), perpendicular to an optical axis (Z-axis), with respect to the base 110. Since the second carrier 410 accommodates a lens unit 200 and a first carrier 310, the lens unit 200 and the first carrier 310 may move on a plane (X-Y plane), perpendicular to the optical axis (Z-axis), along with the second carrier 410.

A second driver 430 may be a portion that provides a driving force to move the second carrier 410 on a plane (X-Y plane), perpendicular to the optical axis (Z-axis), and may include a first sub-driver 430a and a second sub-driver 430b.

The first sub-driver 430a may include a second magnet 431a and a second coil 433a, and the second sub-driver 430b may include a third magnet 431b and a third coil 433b.

In an example, the first sub-driver 430a and the second sub-driver 430b may be separately disposed on the second carrier 410 and the base 110. In an example, the second magnet 431a and the third magnet 431b may be disposed on the second carrier 410, and the second coil 433a and the third coil 433b may be disposed on the base 110. The second magnet 431a and the second coil 433a, and the third magnet 431b and the third coil 433b may face each other when disposed on the second carrier 410 and the base 110, respectively, in the optical axis (Z-axis) direction.

The second magnet 431a and the third magnet 431b may be disposed on one surface of the second carrier 410, and specifically, on a surface facing the base 110 of the second carrier 410 in the optical axis (Z-axis) direction.

A back yoke 453 may be disposed between the second magnet 431a and the second carrier 410 and between the third magnet 431b and the second carrier 410. In an example, the back yoke 453 may be integrally formed with the second carrier 410 by insert injection molding. A portion of the back yoke 453 may be disposed in the second carrier 410, and a remaining portion thereof may be disposed to be exposed to an outside of the second carrier 410. The second magnet 431a and the third magnet 431b may be disposed on an externally exposed portion of the second carrier 410 of the back yoke 453. The back yoke 453 may focus magnetic force of the second magnet 431a and the third magnet 431b, and may prevent occurrence of leakage magnetic flux.

The second coil 433a and the third coil 433b may be disposed on a surface facing one surface of the base 110, and specifically, the second carrier 410 of the base 110 in the optical axis (Z-axis) direction, to face the second magnet 431a and the third magnet 431b, respectively, in an example in which the second coil 433a and the third coil 433b are mounted on one surface of a substrate (hereinafter referred to as a second substrate) 630. In an example, the second substrate 630 on which the second coil 433a and the third coil 433b, or the like are mounted may be disposed on the base 110.

Referring to FIG. 10, the second substrate 630 may include two portions spaced apart from each other on the base 110. The first sub-driver 430a may be disposed on any one of the two portions, and a second sub-driver 430b may be disposed on the other thereof.

The second magnet 431a and the third magnet 431b may be magnetized such that one surface facing the second coil 433a and the third coil 433b has an N pole (or an S pole), a neutral region, and an S pole (or an N pole) in a direction, perpendicular to the optical axis (Z-axis), and as power is applied to the second coil 433a and the third coil 433b, driving force for moving the second carrier 410 in a direction, perpendicular to the optical axis (Z-axis), may be formed.

Referring to FIG. 9, the second carrier 410 may have a shape in which two corner portions facing a support wall 111 are cut in a diagonal direction. The second magnet 431a and the third magnet 431b may be disposed on the second carrier 410 such that longitudinal directions of the second magnet 431a and the third magnet 431b are provided along two corners cut diagonally of the second carrier 410.

Additionally, referring to FIG. 10, the second coil 433a and the third coil 433b may be mounted on the second substrate 630 such that longitudinal directions of the second coil 433a and the third coil 433b are parallel to longitudinal directions of the second magnet 431a and the third magnet 431b.

When power is applied to the second coil 433a and the third coil 433b, a driving force may be formed in a direction, perpendicular to a longitudinal direction of the second magnet 431a and the third magnet 431b, for example, in a width direction of the second magnet 431a and the third magnet 431b, on a plane (X-Y plane), perpendicular to the optical axis (Z-axis), and the second carrier 410 may move in first and second axis directions (X-axis and Y-axis directions), perpendicular to the optical axis (Z-axis) based on a resultant force thereof.

In an example, a rotational force based on an axis parallel to the optical axis (Z-axis) may be generated on the second carrier 410 or the like based on an action of an unintended uneven force in a process of generating a driving force in the first or second axis direction (X-axis or Y-axis direction) (this is also related to an OIS ball guide structure disposed between the second carrier 410 and the base 110, which will be described later).

Therefore, an example camera module 1, in accordance with one or more embodiments, may include a third substrate 650 to offset the above rotational force.

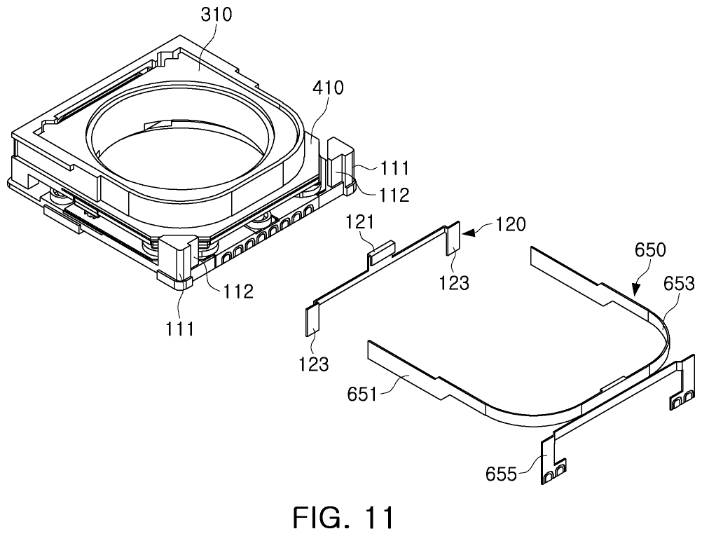

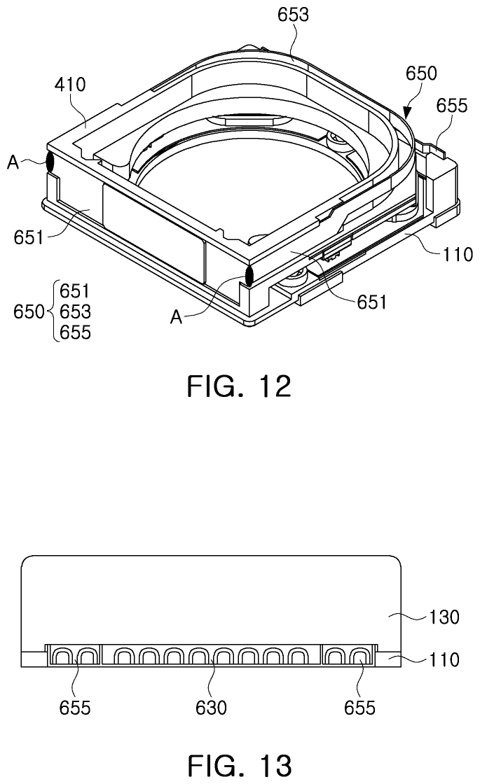

FIG. 11 illustrates a perspective view of an example in which a third substrate is separated from FIG. 7, FIG. 12 is a view illustrating a position to which a first substrate and a third substrate, in accordance with one or more embodiments are coupled, and FIG. 13 is a side view of FIG. 1.

Referring to FIG. 11, a third substrate 650 may be a flexible printed circuit board formed of a flexible material. The third substrate 650 may support a second carrier 410 while moving together with the second carrier 410, when the second carrier 410 moves on a plane (X-Y plane), perpendicular to an optical axis (Z-axis).

The third substrate 650 may be disposed in an external space of the second carrier 410, to cover a portion of a side surface of the second carrier 410.

The third substrate 650 may include a first portion 651 disposed on the side surface of the second carrier 410, a second portion 653 disposed spaced apart from the side surface of the second carrier 410 in a direction, perpendicular to the optical axis (Z-axis), and a third portion 655 supported by a base 110. The first portion 651, the second portion 653, and the third portion 655 may be portions that are continuously formed.

In the third substrate 650, the second portion 653 may be spaced apart from a second carrier 410 along a portion of the external space of the second carrier 410, to support movement of the second carrier 410, and, in particular, the aforementioned rotational force may be offset.

Referring to FIG. 7, the second carrier 410 may have a rounded side portion spaced apart from the second magnet 431a and the third magnet 431b in the optical axis (Z-axis) direction, and the second portion 653 may include a curved region to correspond thereto.

The third substrate 650 may be free from interference of the second carrier 410, since a distance (an air gap) may be provided between the second portion 653 and the second carrier 410.

In an example, the first portion 651 of the third substrate 650 may be disposed on the second carrier 410, and the third portion 655 may be disposed on the base 110.

In an example, the first portion 651 of the third substrate 650 may be connected to a first substrate 610 disposed on the second carrier 410. The first substrate 610 may be disposed on one side surface of the second carrier 410, and both sides of the first substrate 610 may be structurally and electrically connected to the first portion 651. Therefore, the third substrate 650 may transfer power supplied from an outside to the first substrate 610 through the third portion 655.

In an example, the third substrate 650 may connect the first substrate 610 and an external power supply, and thus may be referred to as a connection substrate or a connection board.

The third portion 655 of the third substrate 650 may be supported on the base 110 by a substrate holder 120. The substrate holder 120 may balance and center the second carrier 410, when the third substrate 650 moves together with the second carrier 410.

The substrate holder 120 may include a clip portion 121 into which the second portion 653 of the third substrate 650 is inserted, and a support portion 123 spaced apart in the first axis direction (X-axis direction), perpendicular to the optical axis (Z-axis), based on the clip portion 121, to be seated on a support wall 111 formed in two corner portions of the base 110. The support wall 111 may include a seating groove 112 on an external side surface of which the substrate holder 120 is seated, and the support portion 123 of the substrate holder 120 may be seated in the seating groove 112.

Since the clip portion 121 may be spaced apart from the second carrier 410, the substrate holder 120 may be a member fixed to the base 110 by the support portion 123.

The third portion 655 of the third substrate 650 may have a shape substantially corresponding to a shape of the substrate holder 120. The third portion 655 may be disposed on the support portion 123 attached to the support wall 111, and may be fixed to the base 110.

The third portion 655 may be exposed from a side surface of the base 110, in an example in which a housing unit 100 is coupled, and power may be supplied to the third portion 655. The power supplied to the third portion 655 may be transferred to the first substrate 610.

A second substrate 630 may include a portion exposed to the side surface of the base 110 to receive external power, and may be disposed between the third portion 655.

In an example, a second magnet 431a and a third magnet 431b may be movable members that move along with the second carrier 410 on a plane (X-Y plane), perpendicular to the optical axis (Z-axis), and a second coil 433a and a third coil 433b may be fixed members.

The first sub-driver 430a may include a second position sensor 435a and a first sensing magnet 437a that sense a position of the second carrier 410 in the first axis direction (X-axis direction), perpendicular to the optical axis (Z-axis).

The first sensing magnet 437a may be disposed on one surface of the second carrier 410, and the second position sensor 435a may be mounted on one surface of the second substrate 630, to face the first sensing magnet 437a in the optical axis (Z-axis) direction, together with the second coil 433a. In an example, the second position sensor 435a may be a hall sensor.

The first sensing magnet 437a may be magnetized such that one surface facing the second position sensor 435a has an N pole (or an S pole), a neutral region, and an S pole (or an N pole) in the first axis direction (X-axis direction), perpendicular to the optical axis (Z-axis).

A second sub-driver 430b may include a third position sensor 435b and a second sensing magnet 437b that senses a position of the second carrier 410 in the second axis direction (Y-axis direction), perpendicular to the optical axis (Z-axis) and the first axis (X-axis).

The second sensing magnet 437b may be disposed on one surface of the second carrier 410, and the third position sensor 435b may be mounted on one surface of the second substrate 630, to face the second sensing magnet 437b in the optical axis (Z-axis) direction, together with the third coil 433b. In an example, the third position sensor 435b may be a hall sensor.

The second sensing magnet 437b may be magnetized such that one surface facing the third position sensor 435b has an N pole (or an S pole), a neutral region, and an S pole (or an N pole) in the second axis direction (Y-axis direction), perpendicular to the optical axis (Z-axis) and the first axis (X-axis).

In an example, a pulling yoke 455 may be included to offset a rotational force that may occur when a camera module 1 shakes.

The pulling yoke 455 may be disposed on the base 110 to face the first and second sensing magnets 437a and 437b in the optical axis (Z-axis) direction. The pulling yoke 455 may be formed to have an area to sufficiently cover the first and second sensing magnets 437a and 437b. In an example, the pulling yoke 455 may be provided as a magnetic material, to form an attractive force with the first and second sensing magnets 437a and 437b, and a rotational force generated in the second carrier 410 or the like may be offset by an attractive force acting between the pulling yoke 455 and the first and second sensing magnets 437a and 437b. Additionally, a position of the second carrier 410 may be corrected.

A ball member may be disposed between the second carrier 410 and the base 110, and the ball member may guide movement on a plane (X-Y plane), perpendicular to the optical axis (Z-axis) of the second carrier 410. In an example, a third ball member B3 including a plurality of balls (spheres) may be disposed between the second carrier 410 and the base 110.

The third ball member B3 may include at least three balls (spheres) to support the second carrier 410 or the like. In an example, referring to FIG. 10, the third ball member B3 may include three balls (spheres), and a region connecting thereto may be a triangular region centered on the optical axis (Z-axis).

Referring to FIGS. 3 and 9, the second carrier 410 and the base 110 may include a third guide groove portion G3, respectively, on surfaces facing each other in the optical axis (Z-axis) direction. The third guide groove portion G3 may include a fifth guide groove g5 formed in the second carrier 410, and a sixth guide groove g6 formed in the base 110 to face the fifth guide groove g5. The third ball member B3 may be disposed between the fifth guide groove g5 and the sixth guide groove g6.

The fifth guide groove g5 and the sixth guide groove g6 may be formed to have a size, greater than a diameter of the third ball member B3, such that the third ball member B3 is comfortably accommodated therein. Additionally, the fifth guide groove g5 and the sixth guide groove g6 may have a flat cross-sectional shape such that a motion direction of the third ball member B3 is not constrained in a specific direction. For example, the third ball member B3 may be in contact with the fifth guide groove g5 and the sixth guide groove g6 at one point, respectively. Therefore, the third ball member B3 may move in the first axis and the second axis (X-axis and Y-axis directions), perpendicular to the optical axis (Z-axis), in a state disposed in the third guide groove portion G3.

In an example, the third ball member B3, which guides a movement of the second carrier 410, may move in the first and second axis directions (X-axis and Y-axis) direction), perpendicular to the optical axis (Z-axis), a thickness of the camera module 1 in the optical axis (Z-axis) direction may be reduced.

Additionally, the third ball member B3 may also maintain a distance between the second carrier 410 and the base 110, and furthermore, a distance between the second carrier 410 and a second driver 430 divided into the base 110.

In an example, since the motion direction of the third ball member B3 may not be constrained in a specific direction, the second carrier 410 may be rotated due to a force imbalance in a process of moving the second carrier 410 in the first axis or the second axis direction (X-axis or Y-axis direction), perpendicular to the optical axis (Z-axis). This may be offset and corrected by the third substrate 650 and the pulling yoke 455, described above.

A second yoke 451a and a third yoke 451b may be mounted on the other surface of the second substrate 630. The second yoke 451a and the third yoke 451b may face a second magnet 431a and a third magnet 431b in the optical axis (Z-axis) direction, respectively, and attractive force therebetween in the opposite direction may be acted. The third ball member B3 may maintain contact with the second carrier 410 and the base 110 by the attractive force generated in this manner.

As described above, according to one or more examples, as a focus adjustment unit 300 is accommodated in a shake correction unit 400, a weight of a portion moved in the optical axis (Z-axis) direction during focus adjustment may be reduced, driving stability may be secured, and a focus adjustment operation may be implemented with relatively little driving force.

In an example, the driving stability of a camera module may be improved during focus adjustment. Additionally, since relatively little driving force is needed during focus adjustment, power consumption may be reduced.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A camera module, comprising:
a lens unit comprising at least one lens;
a first carrier, which accommodates the lens unit, and is configured to move in an optical axis direction;
a second carrier, which accommodates the first carrier, and is configured to move on a plane, perpendicular to the optical axis direction; and
a base on which the second carrier is disposed,
wherein a plurality of balls that guide a movement of the second carrier on the plane, perpendicular to the optical axis, are disposed between the second carrier and the base.

2. The camera module of claim 1, wherein the second carrier and the base comprise guide grooves that respectively accommodate the plurality of balls on surfaces that face each other in the optical axis direction, and
wherein the plurality of balls are in contact with the guide grooves at one point, respectively.

3. The camera module of claim 1, further comprising a connection substrate disposed in an external space of the second carrier and formed of a flexible material to support a rotation of the second carrier.

4. The camera module of claim 3, wherein the connection substrate comprises:
a first portion disposed on the second carrier;
a second portion spaced apart from a side surface of the second carrier; and
a third portion disposed on the base,
wherein a portion of the second portion has a curved shape.

5. The camera module of claim 4, further comprising a substrate holder comprising:
a clip portion to which the second portion is fixed; and
a support portion on which the third portion is disposed, and attached to the base.

6. The camera module of claim 3, further comprising:
a first substrate disposed on the second carrier to face the first carrier in a direction, perpendicular to the optical axis direction; and
a second substrate disposed on the base to face the second carrier in the optical axis direction,
wherein the first substrate is connected to the connection substrate.

7. The camera module of claim 1, further comprising:
a first magnet disposed on a first surface of the first carrier; and
a first coil disposed on the second carrier to face the first magnet in a direction, perpendicular to the optical axis direction,
wherein the first carrier is moved in the optical axis direction by an electromagnetic force generated by the first magnet and the first coil.

8. The camera module of claim 1, further comprising:
a second magnet and a third magnet, disposed on a first surface of the second carrier; and
a second coil and a third coil, disposed on the base to respectively face the second magnet and the third magnet in the optical axis direction,
wherein the second carrier is configured to move in a first direction and a second direction, perpendicular to the optical axis direction, based on an electromagnetic force generated by the second magnet and the third magnet and the second coil and the third coil.

9. The camera module of claim 8, further comprising a first sensing magnet and a second sensing magnet, disposed on a first surface of the second carrier,
wherein the first sensing magnet has a shape in which one surface of the first sensing magnet facing the base in the optical axis direction is magnetized in the first axis direction, and
the second sensing magnet has a shape in which one surface of the second sensing magnet facing the base in the optical axis direction is magnetized in the second axis direction.

10. The camera module of claim 9, further comprising a position sensor disposed on the base to respectively face the first sensing magnet and the second sensing magnet in the optical axis direction.

11. The camera module of claim 9, further comprising a pulling yoke disposed on the base to respectively face the first sensing magnet and the second sensing magnet in the optical axis direction,
wherein an attractive force acts between the first sensing magnet and the second sensing magnet and the pulling yoke in opposite directions.

12. An electronic device, comprising the camera module of claim 1.

13. A camera module, comprising:
a base;
a second carrier configured to move relative to the base on a plane, perpendicular to an optical axis direction, and including a rounded portion;
a first carrier configured to move relatively with respect to the second carrier in the optical axis direction; and
a connection substrate configured to support a movement of the second carrier in a state in which a first side of the connection substrate is disposed on the second carrier and a second side of the connection substrate is disposed on the base,
wherein the connection substrate includes a curved region along the rounded portion of the second carrier.

14. The camera module of claim 13, wherein the curved region of the connection substrate is spaced apart from the second carrier in a direction, perpendicular to the optical axis direction.

15. The camera module of claim 13, further comprising:
a second magnet and a third magnet, disposed on the second carrier; and
a second coil and a third coil, disposed on the base to respectively face the second magnet and the third magnet in the optical axis direction,
wherein the second magnet and the third magnet are disposed at positions spaced apart from the rounded portion of the second carrier in the optical axis direction.

16. The camera module of claim 15, wherein the second carrier is configured to move relatively with respect to the base in a first direction and a second direction, perpendicular to the optical axis, by an electromagnetic force generated by the second magnet and the third magnet and the second coil and the third coil, and
wherein the second magnet and the third magnet are disposed on the second carrier such that a longitudinal direction intersects a first axis and a second axis, perpendicular to the optical axis.

17. The camera module of claim 15, wherein the second coil and the third coil are disposed on the base in a state of being mounted on a substrate, and
wherein the substrate comprises a portion on which the second coil is mounted and a portion on which the third coil is mounted, and the second coil and the third coil are structurally separated to be spaced apart from each other on the base.

18. An electronic device, comprising the camera module of claim 13.

19. A camera module, comprising:
a base;
a first carrier configured to move in an optical axis direction;
a second carrier configured to accommodate the first carrier, and further configured to move in a direction perpendicular to the optical axis direction; and
a connection board, connected to the base and the second carrier, and configured to support the second carrier, and move together with the second carrier when the second carrier moves in the direction perpendicular to the optical axis direction.

20. An electronic device comprising the camera module of claim 19.
